(19) United States
(12) Patent Application Publication
(10) Pub. No.: US 2026/0286742 A1
(43) Pub. Date: Sep. 24, 2026

(54) MECHATRONIC SECURITY SYSTEM FOR ALARM MONITORED LOCKS AGAINST UNAUTHORIZED OVERRIDING

(71) Applicant: Thomas MATOUSCHEK, Bietigheim-Bissingen (DE)

(72) Inventor: Thomas MATOUSCHEK, Bietigheim-Bissingen (DE)

(21) Appl. No.: 19/088,900

(22) Filed: Mar. 24, 2025

(51) Int. Cl. E05B 45/06; E05B 47/00; G08B 13/04

(52) U.S. Cl. CPC E05B 45/06; E05B 47/0001; G08B 13/04; E05B 2045/0695

(57) ABSTRACT

A mechatronic security device includes a security member configured to be locked in an abutment, which includes a predetermined breaking point in the bolt guide and a recess for notification circuit board. The security device is also equipped with a predetermined breaking point, which has a recess around the web that guides the power conductor and in this way permanently monitors the security member. In the event of an illegal attack, the predetermined breaking points and the power conductor are destroyed, and an alarm is triggered before the bolt strikes the wall of the security device and offers mechanical resistance.

### TECHNICAL FIELD

The invention relates to a mechatronic security system for alarm-monitored locks to prevent unauthorized access, for example for secure safes or sliding and casement windows. However, the invention is not limited to this, but is explained using the function of a sliding window.

### RELATED ART

As sliding windows are operated either vertically or horizontally, or casement windows are swung out, there is currently no sensible mechatronic burglar alarm that can be used for all applications. For this reason, mechanical security systems are currently used to protect against burglary, at most in conjunction with an electronic contact (opening detector) or motion detectors indoors.

Purely mechanical security can be overridden with the appropriate force and opening detectors, as the name suggests, only detect the opening of the object lock. Almost at the same time as the alarm is triggered, the attacker can already get in, or if motion detectors are used, the attacker is already inside the property. Apart from the frequency of false alarms, an intervention has little chance of preventing a successful break-in. Large-scale police studies in Germany have shown that only one in 106 alarms was a genuine alarm, while 105 were false alarms. The study also found that 52 percent of properties equipped with electronic security were successfully broken into and that the burglars had already fled with the loot by the time the intervention arrived.

Opening detectors, usually reed switches with an opposing magnet, are suitable for ensuring 360-degree monitoring of a building opening. However, these detectors are purely electronic detectors that must always be armed for monitoring or disarmed for non-monitoring, for example before legal opening. Permanent arming is only possible with these detectors if the object lock to be monitored, for example a sliding window, is never legally opened. Furthermore, as the name suggests, they only detect opening.

Various mechanical and/or electronic security products are therefore currently required to protect against burglary, particularly for vertical, horizontal sliding, casement windows and lift and slide doors. There is currently no mechatronic security product that can be used universally for the various windows and doors, both for the residential and commercial sectors, that monitors absolutely without false alarms and also ensures escape from the property at all times, such as the one on which the invention is based.

To ensure an escape route from inside of a building, for example in the event of a fire, a security system is required that must not be locked and does not require prior identification. It must be possible to open the security from the inside in seconds, for example to escape in the event of a fire. The security on which the invention is based ensures this. However, it presupposes that the operators are capable of acting and are two-handed.

### SUMMARY

The following descriptions of the invention show that one and the same product can fulfill all of these aforementioned claims.

Mechatronic security by overriding predetermined breaking points and destroying notification circuit boards is state of the art, see for example U.S. Ser. No. 17/793,908. However, what differentiates this invention from the state of the art, is a security device that combines various components. For example, a bolt is manually inserted from the security, fitting through a specially manufactured conductor track located in front of a predetermined breaking point, then through a larger opening in the security and then through a guide sheet with breaking point. This security offers the following advantages:
It can be used universally in almost all object closures
It can remain permanently armed (365/24/7),
for technical reasons, it does not trigger false alarms,
it can trigger an alarm at the beginning of the attack after the predetermined breaking points were overridden
it can then use mechanical resistance to keep the attacker outside the object for some time
It can thereby give the intervention a chance
It complies with fire protection regulations
It can be unlocked from the inside at any time in the event of an escape and
It cannot, or only with great difficulty, be attacked from outside the object

Although many engineers are employed in the burglary protection sector by the manufacturers of protection technologies, none of them have yet had the idea of implementing the technologies on which the invention is based in a complete product such as that described in the invention.

### BRIEF DESCRIPTION OF THE DRAWINGS

FIG. 1 shows a top view of the locked security and the abutment in a simple embodiment.

FIG. 2 shows a side view of the outside of the end wall of the security 1 with the guide sheet 9 and the predetermined breaking points 20.

FIG. 3 shows a side view of the inside of the end wall of the security 1 with the special notification circuit board 10.

FIG. 4 shows a side view of the inside of the end wall of security 1 with the notification circuit board 10 in the event of an illegal attack and alarm triggering.

FIG. 5 shows the security 1 and the abutment in the unlocked state

FIG. 6 shows the locking mechanism of a safe

FIG. 7 shows the circuit diagram of security 1 in the locked and closed state.

FIG. 8 shows the circuit diagram of security 1 in the unlocked and open state.

FIG. 9 shows the circuit diagram of security 1 after an attack and alarm triggering.

### DETAILED DESCRIPTION

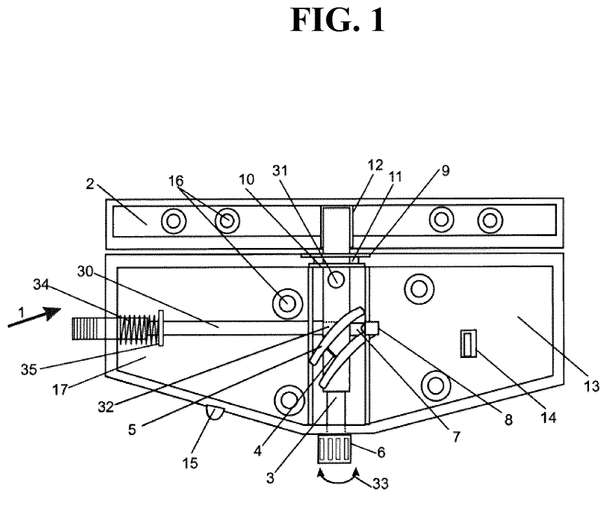

FIG. 1 shows the security (herein interchangeably used with security member or security part) 1 and the abutment 2 in the locked state. Normally, the security 1 is mounted on the fixed part of an object opening and the abutment on the sliding part. This can also be done in reverse.

The bolt 3, which can be operated with the handle 6, is locked in the recess 12 in the abutment 2. During the rotation 33 of the handle 6, the bolt 3 can be rotated by 90 degrees, while the guide bar 7 is guided by the bolt guide 5 to the bolt stop 4, with simultaneous retraction of the bolt locking means 30 from the recess 31, during the opening or locking process. During this rotary movement, the bolt 3 is automatically either unlocked or locked in the abutment 2 by the bolt guide 5. The bolt locking means 30 anchored in the bolt 3 and the simultaneous rotating and pulling movement of the handle 6 would prevent unlawful unlocking from outside the building under attack by reaching through a smashed window pane with one hand.

To make it at least more difficult for an attacker to unlock the security 1, the bolt locking means 30 has to be pulled out of the bolt 3 before unlocking and at the same time the bolt 3 on the handle 6 has to be pulled back by means of the rotary movement 33. Only now can the security 1 be unlocked, which is why both hands are required for unlocking. An attacker from the outside, reaching through an opening in the glass pane, has virtually no way of unlocking the security 1 with both hands without sustaining significant cuts. In addition, even breaking the glass pane could trigger an alarm via a glass breakage detector.

When locked, the bolt 3 is fixed in place by the guide sheet 9 mounted on the security 1 with screws with breaking points 20 and guided through a suitable recess 28 in the notification circuit board 10. There is a clearance in the bolt passage of the security 1. In the event of an illegal attack, this clearance 11 is required to override the guide sheet 9 with the screws with breaking point 20 and simultaneously trigger the alarm via the notification circuit board 10. The function of the guide sheet 9, the notification circuit board 10 and the clearance for notification circuit board 11 will be shown in further Figures and descriptions.

In the event of a forceful operation, the screws with breaking point 20 that fix the guide sheet 9 break. The guide sheet 9, which surrounds the bolt 3, is now pressed in the respective direction of the forceful operation. If the clearance 11 in the security 1 is overridden, the bolt strikes the security 1. At the same time, the bolt 3 pushes the power conductors 23 attached to the inner part 25 of the notification circuit board 10 into the recess 26 of the notification circuit board 10, destroying the power conductors 23 and triggering an alarm with no false alarms. After the alarm is triggered, the bolt 3 which is fixed in the abutment 2, strikes the wall of the security 1 after overriding the clearance 11 and thus provides the actual or physical resistance to the attacker. The intervention can use this time period to override this resistance.

The solution which the invention is based on creates a product that can be operated from inside the building at any time, even in the event of an escape. In the event of an escape, no clear identification may take place from a fire police perspective. In order to still provide the greatest possible protection, the security on which the invention is based was designed in such a way that it can be operated with two hands inside the object, but can hardly be unlocked from the outside. This is achieved by preventing the bolt 3 from being unlocked by means of a bolt locking means 30. When locked, the recess for the locked bolt locking means 30 engages in the recess 32 in the bolt 3 and in this way prevents unauthorized unlocking from the outside. If the security 1 is to be unlocked, the bolt locking means 30 must first be pulled out of the recess 32 in the bolt 3 and the bolt 3 must be pulled back by turning the handle 6 with the second hand. When the security 1 is unlocked, the bolt locking means 30 is pressed into the recess 31 in the bolt 3 so that accidental locking in the open state of the object opening to be secured is prevented.

In the locked state, the guide bar 7 switches the end switch 8 so that an evaluation unit (alarm center or similar) is informed that the door is locked and the diode 15 which lights up green indicates the locked state.

A sabotage switch 14 is installed on the circuit board 13 on which the electronic components can be mounted. It monitors any unjustified opening of the security 1 and would forward this as an alarm. Rechargeable or primary batteries or other power storage devices can be accommodated in the free space 17.

The other functions are explained using the figures below.

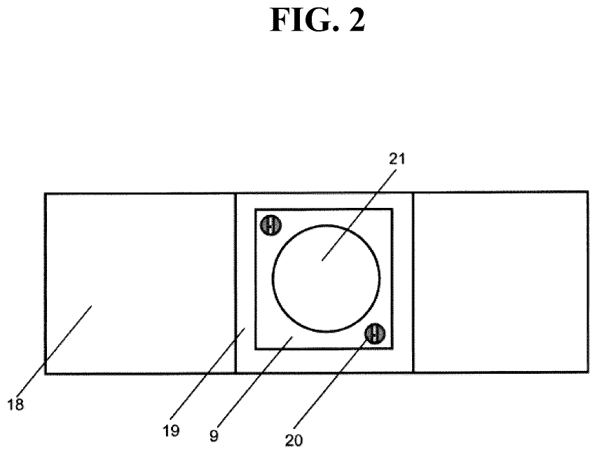

FIG. 2 shows a side view of the outside of the end wall 18 of the security 1 with the guide sheet 9, which fits around the bolt 3 and is fixed to the security 1 by the screws with breaking point 20.

The guide sheet 9 is attached to the outside of the end wall 18 of the security 1 with the screws with breaking point 20 in the area of the clearance 19. The bolt 3, which is not shown, is configured to be guided to fit in the recess 21.

If force is applied to the window to be secured, the screws with breaking point 20 break and the guide sheet 9 is pushed into the clearance 19. The clearance 19 allows the guide sheet 9 to be moved in horizontal, vertical and diagonal directions.

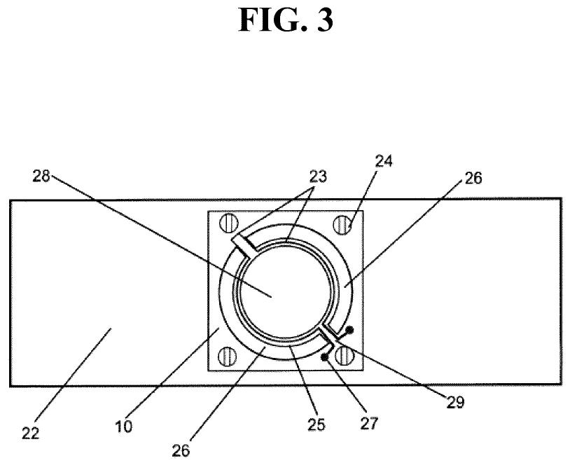

FIG. 3 shows a side view of the notification circuit board 10 on the inside of the end wall 22 of the security 1. The notification circuit board 10 is firmly fixed to the inside of the end wall 22 of the security 1 with the screws 24, has a recess 28 in which the bolt 3 is guided to fit and is held in position by the guide sheet 9.

A recess 26 is provided between the circuit board part 25, on which the all-round power conductors 23 are attached, and the outer part of the notification circuit board 10. The notification circuit board 10 has a recess 26 and is connected to the current-conducting inner part 25 by two destructible webs 29. At the terminals 27, the notification circuit board 10 can be connected to a monitoring unit (not shown).

If, in the event of an illegal attack, a force is applied to the bolt 3 that is greater than the resistance of the screws with breaking points 20 of the guide sheet 9, the screws with breaking points 20 break and the bolt is pushed to the stop of the clearance 11 in the security 1, where it makes a stable stop. In doing so, the bolt 3 forcibly destroys the power conductor 23 in the inner part 25 of the notification circuit board 10, as the bolt 3 is now pressed into the recess 26. The destruction of the inner part 25 carrying the power conductor 23 can trigger an alarm. The bolt then strikes the end of the clearance 11 in the security part 1 and now provides the attacker with the actual and physical resistance that costs him time. The electronic monitoring functions, regardless of the direction of the attack, in the event of an attack.

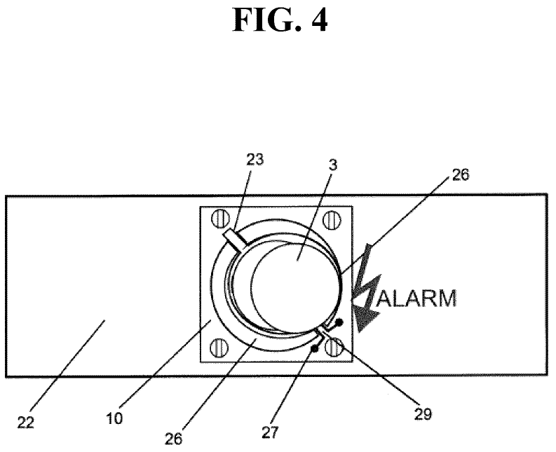

FIG. 4 shows a side view of the inside of the end wall 22 of the security 1 with the notification circuit board 10 during an illegal attack.

If an object opening, which is provided with the security according to the invention, is illegally attacked, the screws with breaking point 20 of the guide sheet 9 break when the force exceeds the predetermined breakage force of the breaking point 20. The guide sheet 9 is now pressed to the side into the clearance 19. This destroys the inner part 25 of the notification circuit board 10 and thus interrupts the applied power conductors 23. Due to the power interruption, the alarm can be triggered. The bolt 3 then strikes the wall of the security 1, as already described, and offers mechanical resistance.

As can be seen in FIG. 4, the inner part 25 guiding the power conductor 23 detects all violent attacks after breaking, be they from vertical, horizontal or diagonal force. This enables mechatronic security that can be used for almost all applications.

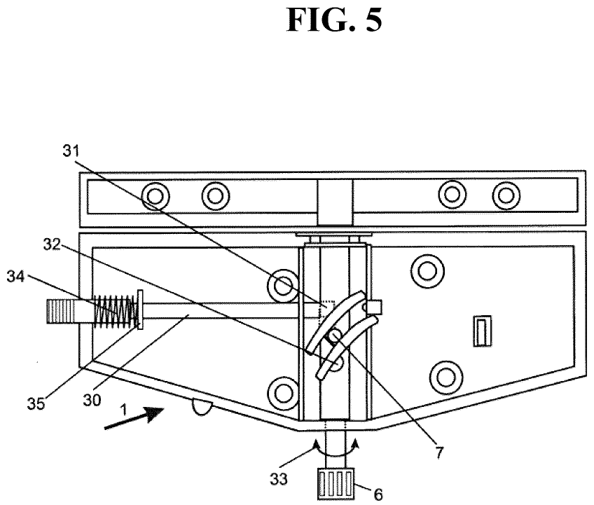

FIG. 5 shows the security 1, unlocked in the abutment 2, provided with a bolt locking means 30 which is located in the recess 31 and thus blocks the bolt 3 from advancing.

To unlock the security 1 from the abutment 2, the bolt locking means 30 must be pulled back out of the second recess 32 against the resistance of the spring 34, which is supported by the stop 35, thus releasing the bolt 3. At the same time, the bolt 3 is moved out of the abutment 2 in a rotary movement via the handle 6. At the end of the unlocking process, after the guide bar 7 of the bolt 3 abuts the bolt stop 4, the bolt locking means 30 can slide into a first recess 31 in the bolt and thus retains it in the unlocked position. In order to avoid carelessly extending the bolt 3 when a window is open, into the abutment 2, and then accidentally destroying the screws with breaking point 20 and thus the notification circuit board 10 when the object opening is forcibly closed with the extended bolt 3, the bolt 3 is fixed in the first recess 31 when open.

### As already described, unlocking requires the use of both hands.

The security device on which the invention is based is not limited to the bolt locking means 30 shown; other such or similar bolt or handle locking devices can be provided if necessary. Likewise, the rotary movement of the bolt 3 for locking or unlocking is not a prerequisite for the functioning of the security device 1.

When the security 1 is unlocked, the end switch 8 has opened and thus communicated the opening status to an alarm center. This status may be communicated to the operator of this system via the diode 15, which may light up in red.

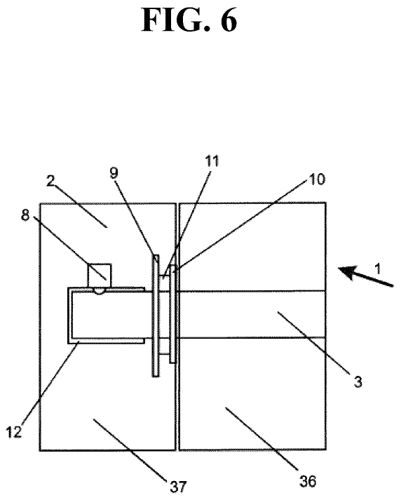

FIG. 6 shows the security 1 installed in a safe. When locking, a bolt 3 is guided from the door 36 of the safe into the body 37 of the safe and locked therein. As described in FIG. 1, the bolt 3 is monitored electronically by means of the predetermined breaking points.

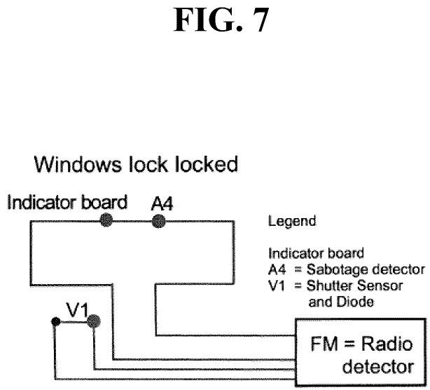

FIG. 7 shows the circuit diagram of the security 1 in the locked state. The notification circuit board 10 and the sabotage detector A4 are in the monitoring state. The switch 8 (V1) informs the monitoring unit (not shown) and a diode 15 that the security 1 is locked in the abutment 2.

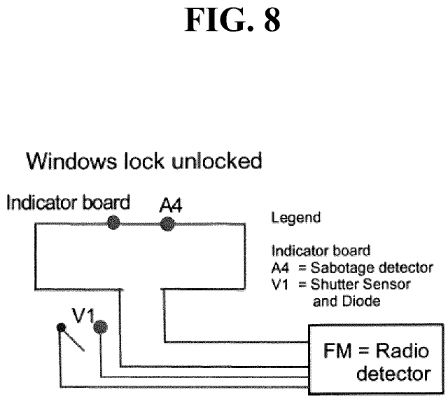

FIG. 8 shows the circuit diagram of security 1 in the disarmed state. As the notification circuit board 10 and the sabotage detector A4 do not need to be disarmed, the switch 8 (V1) indicates the opening status both via the diode 15 and the monitoring unit.

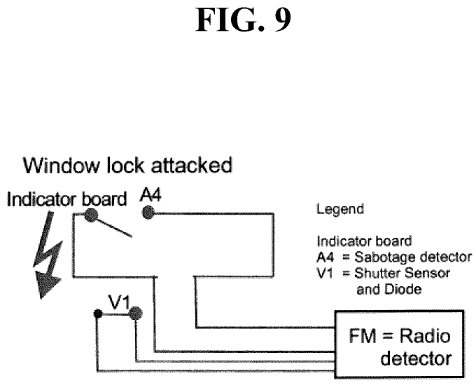

FIG. 9 shows the circuit diagram of the security device 1 when it has been overridden by force and the resulting alarm triggering. The bolt 3 has overcome the screws with breaking point 20 of the guide sheet 9 as a result of the application of force, has penetrated into the clearance 11 and thereby into the recess 26 of the notification circuit board 10, thereby interrupting the conductor path 23 of the notification circuit board 10 and triggering an alarm. The bolt 3 then strikes the wall of the security 1 and offers renewed resistance.

### LIST OF REFERENCE SIGNS

1 security member
2 abutment
3 bolt
4 Bolt stop
5 Bolt guide
6 Handle
7 Guide bar
8 End switch
9 Guide sheet with breaking point
10 Notification circuit board
11 Clearance in the bolt passage of the security 1
12 Recess for bolt in abutment 2
13 Current board for electronic unit
14 Sabotage switch
15 Diode
16 Recess for screw joint
17 Space for power supply
18 End wall of the security outside
19 Clearance for guide sheet
20 Screws with breaking point
21 Recess matching the bolt 3
22 End wall for the security 1 inside
23 Power conductor
24 Screw joint of notification circuit board
25 Inner part of the notification circuit board 23 with power conductor
26 Recess for notification circuit board
27 Terminals for the notification circuit board 23
28 Recess for the bolt 3
29 Support pin in the notification circuit board
30 Bolt locking means
31 Recess for locking of the unlocked bolt locking means 30
32 Recess for the locked bolt locking means 30
33 Rotation of handle 6
34 Spring
35 Spring abutment
36 Door of the safe
37 Wall of the safe

What is claimed is:

1. A security device for object locks, comprising:
a security member;
an abutment;
a locking device for the security member, which is configured to lock the security member in the abutment; and
an alarm monitoring device,
wherein a bolt is configured to be locked or unlocked manually or electrically from the security member into the abutment,
wherein at least one bolt locking means obstructs unauthorized unlocking of the security member,
wherein, in a locked state, the bolt is guided in the security member surrounded by a predetermined breaking point,
wherein the bolt is further surrounded by a 360 degree monitoring member having a predetermined breaking point within a notification circuit board,
wherein the notification circuit board has a web configured to guide at least one conductor track,
wherein a recess is formed around the web,
wherein, in response to a predetermined force being applied, the web with the at least one conductor track breaks securely, a power conductor is thereby interrupted, an alarm is triggered accordingly, the bolt then strikes against a stop in the security member, and an attacker is thus deprived of time to override the alarm, thereby allowing for escape from a building.

2. The security device according to claim 1, wherein at least one mechanical and/or electronic bolt locking means obstructs unauthorized unlocking of the security member.

3. The security device according to claim 1, wherein the security member remains permanently armed after installation.

4. The security device according to claim 1, wherein locking of the security member in the abutment is controlled by an alarm system and/or by means of a time recording system.

5. The security device according to claim 1, wherein a status monitoring device is provided for monitoring a status of interlock and for supplying information associated with the status to an alarm system and/or by means of a time recording system to a monitoring center or a control unit.

6. The security device according to claim 1, wherein at least one of a glass breakage detector, a tampering detector, or a radio transmission unit is connected to the security device.

7. The security device according to claim 1, wherein the security member requires two-hand operation for unlocking.
